(19) United States
(12) Patent Application Publication
(10) Pub. No.: US 2013/0092741 A1
(43) Pub. Date: Apr. 18, 2013

(54) WIRELESS SMART CARD AND INTEGRATED PERSONAL AREA NETWORK, NEAR FIELD COMMUNICATION AND CONTACTLESS PAYMENT SYSTEM

(71) Applicants: Michael Loh, Calgary (CA); Ambrose Tam, Calgary (CA)

(72) Inventors: Michael Loh, Calgary (CA); Ambrose Tam, Calgary (CA)

(21) Appl. No.: 13/651,369

(22) Filed: Oct. 12, 2012

Related U.S. Application Data
(62) Division of application No. 12/234,499, filed on Sep. 19, 2008, now abandoned.

(51) Int. Cl. G06K 19/07

(52) U.S. Cl. CPC G06K 19/0723
USPC 235/492

(57) ABSTRACT

A wireless smart card having a personal area network transceiver, such as a Bluetooth transceiver, to couple the wireless smart card with a mobile communication device, and a near field communication (NFC) and radio-frequency identification (RFID) transceiver to couple the wireless smart card to a wireless transaction device, and a transponder with a secure element to allow secure communications between the mobile communication device with the wireless smart card and the wireless smart card and the wireless transaction device is described. The wireless smart card allows, for example, contactless payment through a Bluetooth-enabled mobile communication device without modification to the mobile communication device.

### PRIORITY

The present application claims priority to U.S. Provisional Application Ser. No. 60/974,424, filed Sep. 21, 2007, and U.S. patent application Ser. No. 12/234,499, filed Sep. 19, 2008, the entirety of both of which are hereby incorporated by reference.

### BACKGROUND

1. Field

The subject invention relates to a wireless smart card configured for contactless payment transactions, methods for contactless transactions using the wireless smart card and a system for contactless transactions using the wireless smart card.

2. Related Art

Mobile communication devices, including cellular phones, personal digital assistants (PDAs), other types of mobile phones, and the like, (herein collectively referred to as mobile communication devices or mobile phones) are being used not just for communication (voice and text), but also to take photos, send text messages, listen to music, surf the Web, do word processing, watch movies and the like. Consumers have also become interested in using their mobile communication devices to perform various transactions (e.g., transfer funds, purchase products, etc.). Contactless payment standards have recently been developed for contactless payment systems that optionally can be used with these mobile communication devices. In order to carry out a contactless transaction, any transponder or contactless transaction component must comply with these standards. The contactless payment systems and standards have been implemented by credit card issuers such as Mastercard (PayPass), Visa, etc, which have issued special credit cards that have passive contactless transponders that can be used for the contactless payment transactions. In addition, contactless payment has been implemented by integrating near field communications (NFC) into mobile communication devices or by using a Bluetooth proprietary feature of the mobile communication devices. The contactless payment systems have been used with various communication standards. NFC is an open standard communication system that was designed by Philips and Sony Corporation, and enhanced by the NFC forum. NFC uses Radio Frequency Identification (RFID) based technology and must comply with various standards and operating protocol/frequency for RFID.

Adoption of mobile communication devices that are capable of contactless payment, however, has been slow. Few mobile communication devices have implemented the technology due to technical, certification, standardization and other business issues. Also, users are required to replace their existing mobile communication devices with the mobile communication devices that have the technology to perform the transactions before they can conduct these contactless transactions. Users will also have to cancel or transfer their payment accounts, stored coupon or stored monetary credits when they change phones.

### SUMMARY

The following summary of the invention is included in order to provide a basic understanding of some aspects and features of the invention. This summary is not an extensive overview of the invention and, as such, it is not intended to particularly identify key or critical elements of the invention or to delineate the scope of the invention. Its sole purpose is to present some concepts of the invention in a simplified form as a prelude to the more detailed description that is presented below.

According to one aspect of the invention, a wireless smart card comprises a personal area network (PAN) interface; a near field communication (NFC) and radio frequency identification (RFID) transceiver; a secure element coupled to the NFC and RFID transceiver; a processor coupled to the PAN transceiver, the NFC and RFID transceiver and the secure element; and a memory coupled to the processor.

According to an aspect of the invention, a method is provided for receiving a request to activate a secure communication link at a secure element of a wireless smart card from a mobile device; establishing the secure link to the mobile device through a personal area network (PAN) transceiver; and storing applets and user credentials at the secure element through the secure link.

According to another aspect of the invention, a wireless smart card comprises a first wireless transceiver to wirelessly communicate with a mobile communication device through a first communication protocol; a second wireless transceiver to wirelessly communicate with a transaction device through a second communication protocol; a secure element having a processor and a secured flash memory to store applets and user credentials, the secure element coupled to the first wireless transceiver and the second wireless transceiver; and a logic and processing controller coupled to the first wireless transceiver, second wireless transceiver and the secure element.

According to yet another embodiment of the invention, a wireless smart card comprises a first wireless transceiver to wirelessly communicate with a mobile communication device through a first communication protocol; a second wireless transceiver to wirelessly communicate with a transaction device through a second communication protocol; and a secure element to store secure data and to enable secure operations to be conducted via wireless communications between the mobile communication device, the wireless smart card, and the transaction device.

According to another aspect of the invention, a wireless smart card system comprises a mobile communication device; a transaction device; and a wireless smart card comprising a first wireless transceiver to wirelessly communicate with said mobile communication device through a first communication protocol; a second wireless transceiver to wirelessly communicate with said transaction device through a second communication protocol; and a secure element to store secure data and enable secure operations to be conducted by said system via wireless communications between the mobile communication device, the wireless smart card, and the transaction device.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a block diagram of a wireless smart card system in accordance with one embodiment of the invention;

FIG. 2 is a block diagram of a wireless smart card system in accordance with one embodiment of the invention;

FIG. 3 is a more detailed block diagram of the wireless smart card shown in FIGS. 1 and 2 in accordance with one embodiment of the invention;

FIGS. 4A and 4B are flow diagrams of a power on procedure in accordance with one embodiment of the invention;

FIGS. 5A and 5B are flow diagrams of a pairing procedure in accordance with one embodiment of the invention;

FIGS. 6A and 6B are flow diagrams of a provisioning procedure in accordance with one embodiment of the invention;

FIG. 7 is a data flow diagram for the provisioning process of FIGS. 6A and 6B in accordance with one embodiment of the invention;

FIGS. 8A and 8B are flow diagrams of a network transaction procedure in accordance with one embodiment of the invention;

FIG. 9 is a data flow diagram for the network transaction process of FIGS. 8A and 8B in accordance with one embodiment of the invention;

FIGS. 10A and 10B are flow diagrams of a contactless transaction procedure in accordance with one embodiment of the invention;

FIG. 11 is a data flow diagram for the contactless transaction process of FIGS. 10A and 10B in accordance with one embodiment of the invention;

FIGS. 12A and 12B are flow diagrams of a contactless read/write procedure in accordance with one embodiment of the invention;

FIG. 13 is a data flow diagram for the contactless read/write process of FIGS. 12A and 12B in accordance with one embodiment of the invention;

FIGS. 14A and 14B are flow diagrams of a peer to peer procedure in accordance with one embodiment of the invention;

FIG. 15 is a data flow diagram for the peer to peer process of FIGS. 14A and 14B in accordance with one embodiment of the invention;

FIG. 16 is a data flow diagram for a local transaction process in accordance with one embodiment of the invention;

FIG. 17 is a schematic drawing of a key fob wireless smart card in accordance with one embodiment of the invention;

FIG. 18 is a block diagram of a wireless smart card system in accordance with another embodiment of the invention; and

FIG. 19 is a block diagram of a wireless smart card in accordance with one embodiment of the invention.

### DETAILED DESCRIPTION

Embodiments of the invention relate to a wireless smart card that can be used to conduct contactless transactions, etc., which also includes the ability to communicate with and be managed by a mobile communication device, such as a cellular phone via a conventional personal communication network (PCN) or personal area network (PAN). In one embodiment, the wireless smart card communicates with the mobile communication device through use of the well known Bluetooth wireless protocol. Contactless transactions that can be performed with the wireless smart card include contactless payment, near field communication (NFC) with other NFC devices (i.e. peer-to-peer communication), and Radio Identification (RFID) reading/writing, which can be made in a secure and efficient manner. The wireless smart card can be used to provision or modify secure personal credentials, store and modify monetary values, upload or review transactions, and read and download information from external transaction devices, such as smart posters and other NFC or RFID devices. Because the wireless smart card can communicate with both the mobile communication device and the external transaction devices, users are not required to change their mobile communication devices. In addition, users who have multiple mobile communication devices can use the wireless smart card for contactless payment, near field communication or other transaction functions using any of their mobile communication devices that support PCN's.

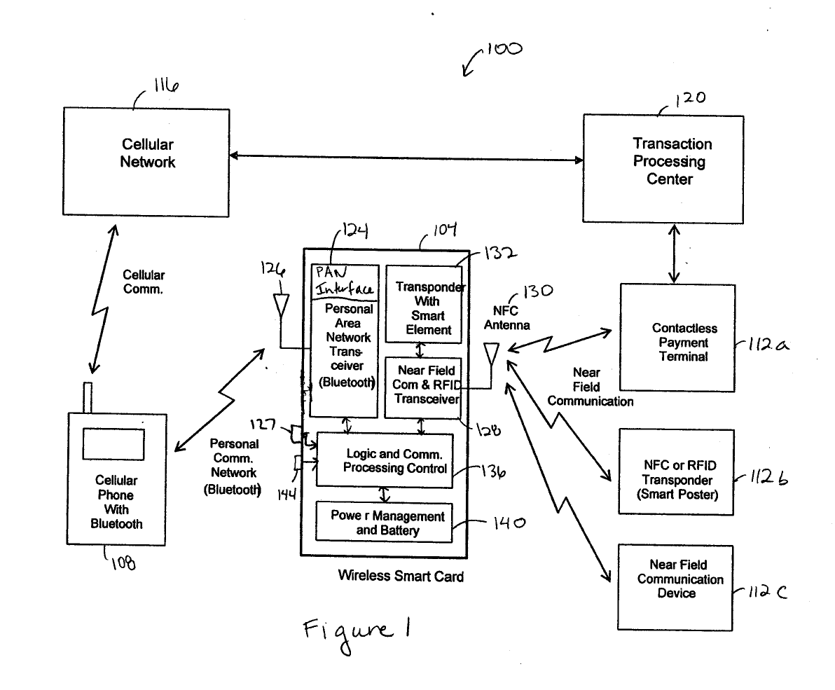

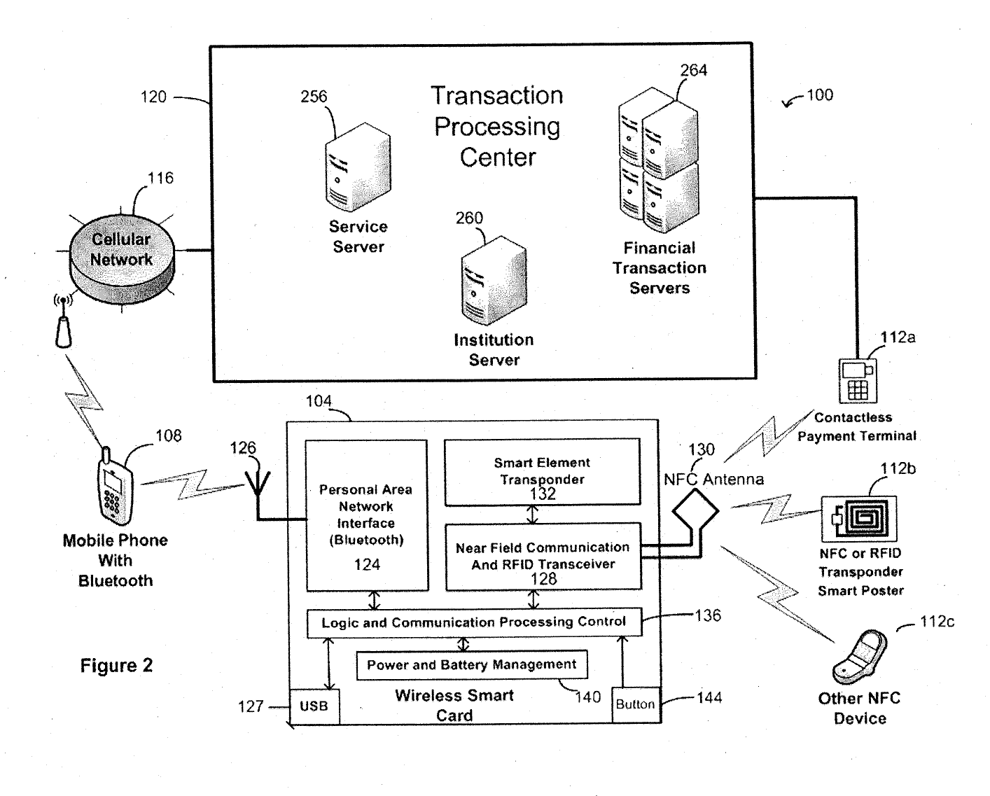

An embodiment of the invention will now be described in detail with reference to FIGS. 1 and 2. FIGS. 1 and 2 illustrate an exemplary smart card contactless transaction system 100. It will be appreciated that the contactless transaction system 100 may include additional or fewer components and the arrangement of the components may differ from that shown in FIGS. 1 and 2. In FIG. 1, the contactless transaction system 100 includes a wireless smart card 104, a mobile communication device 108, a transaction device 112, a cellular network 116 (or other wireless communication network) and a transaction processing center 120. The wireless smart card 104 is configured to read, upload download, or exchange information between the transaction device 112 and the mobile communication device 108.

The wireless smart card 104 includes a personal area network (PAN) transceiver 124, a PAN antenna 126, a USB port 127, a near field communication (NFC) and radio frequency identification (RFID) interface 128, a NFC antenna 130, a transponder with a secure element 132, a logic and communication processing control 136, a power management and battery 140 and a manually operable input device 144, e.g. a switch, button or keyboard. It will be appreciated that although the NFC and RFID interface 128 is shown as one NFC and RFID transceiver, the NFC and RFID interface 128 may include multiple transceivers, such as one NFC transceiver and one RFID transceiver, or one or more NFC transceivers and one or more RFID transceivers, or just one NFC transceiver or just one RFID transceiver. USB port 127 enables an external device to be connected to wireless smart card 104 via a wired link.

In one embodiment, the logic and communication processing control 136 includes a CPU and memory. The wireless smart card 104 includes multi-mode operation controls and corresponding software/protocols that automatically detect, switch and enable various modes of operations, transactions and applications. The power management and battery circuit 140 may include a charger and/or a rechargeable battery. The rechargeable battery may be, for example, a lithium ion battery.

In one embodiment, the secure element 132 is a Secure Access Module (SAM) known in the art. The secure element 132 is configured to store applets that are configured to enable the wireless smart card 104 to enable transaction and communication functions. The secure element 132 is also configured to store secure data, such as user credentials, transaction data, and the like.

The wireless smart card 104 can be packaged into various form factors to suit the look, feel and operation required for the user and such that the wireless smart card 104 is portable. In one embodiment, the wireless smart card 104 is, for example, a key fob, a card (e.g., credit card size), a wrist or watch band, a phone attachment, and the like.

The mobile communication device 108 is typically a cellular phone, but it will be appreciated that the mobile communication device 108 may be other mobile computing devices, such as a Personal Digital Assistant (PDA), Tablet Personal Computer (Tablet PC), and the like. The mobile communication device 108 includes a transceiver (not shown) for communicating with the wireless smart card 104 through the PAN transceiver 124 of the wireless smart card 104. In one embodiment, the mobile communication device 108 and wireless smart card communicate via Bluetooth. Bluetooth is a wireless communication protocol for creating personal area networks using a frequency hopping spread spectrum at about 2.4 GHz. It will be appreciated that other wireless peer-to-peer communication methods may be used including, for example, a Personal Communication Network (PCN), Ultra Wide Band, WiFi, etc. It will be appreciated that the mobile communication device 108 and wireless smart card 104 may also communicate through a USB connection, as shown at 127, or via some other wired connection.

The transaction device 112 and the wireless smart card 104 communicate using NFC or RFID at the NFC and RFID interface 128. The transaction device 112 may be, for example, a contactless payment terminal 112a, an NFC or RFID transponder 112b, a near field communication (NFC) device 112c, and the like, and combinations thereof. Exemplary NFC or RFID transponder devices 112b include e-Posters, contactless labels, RFID tags, etc.

The wireless smart card 104 also includes a transponder with secure element 132 configured to store credit credentials, user authentication information and the like, to enable secure communications between the wireless smart card and a transaction processing center 120 using the wireless networks of the mobile communication device 108 and the transaction device 112 (e.g., Bluetooth and NFC and/or RFID networks, respectively).

The transaction processing center 120 includes, for example, banks, credit card issuers, cellular operators and/or payment service providers that are involved in processing transactions, as known in the art. As shown in FIG. 2, the transaction processing center 120 may include a service server 256, an institution server 260, and financial transaction servers 264.

In operation of a system according to the present invention, the transaction processing center 120 opens a secure communication channel to the wireless smart card 104 via a dedicated or virtual private network (from the transaction processing center 120 to the cellular operating station), a cellular network (from the cellular operating station to the mobile communication device 108), and Bluetooth (from the mobile communication device 108 to the wireless smart card 104). Through the secure communication channel, the transaction processing center 120 can exchange secure protocols with the wireless smart card 104, and download or modify the applets in the flash memory of the secured secure element in the wireless smart card 104. The transaction processing center 120 can also activate, download or modify other secure content such as payment account credentials, coupons, or monetary credits to the wireless smart card 104 for payment or other transactions. The transaction processing center 120 can also activate, store or modify the applets, user credentials or other transaction contents via Near Field Communication or RFID between the transaction device 112 (e.g., contactless payment terminal 112a) and the wireless smart card 104.

The wireless smart card 104 can be used for transactions (e.g., credit or debit payments) by presenting the wireless smart card 104 at the contactless payment terminal 112a. In the transaction mode of operation, the contactless payment terminal 112a communicates with the applets and credentials stored in the secure element 132 through the NFC and/or RFID interface 128 using NFC according to a standard transaction protocol. The transaction and authorization is then processed between the contactless payment terminal 112a and transaction processing center 120 using standard transaction processing.

Transaction information (e.g., payment, balance, coupon, etc) can be communicated from the wireless smart card 104 to the mobile communication device (e.g., cellular phone) via Bluetooth communication using the PAN transceiver 124. Clearance of transactions can be performed by communication with the transaction processing center 120 through a wireless network (e.g., cellular network 116). Transaction information can also be sent from the transaction process center 120 to the mobile communication device 108 using SMS (Short Messages Services) or other cellular data services. Clearance of the transaction can be performed by contactless transaction modes. Transaction information (or most recent information) can also be stored in the wireless smart card 104 for later retrieval through a mobile device or a PC.

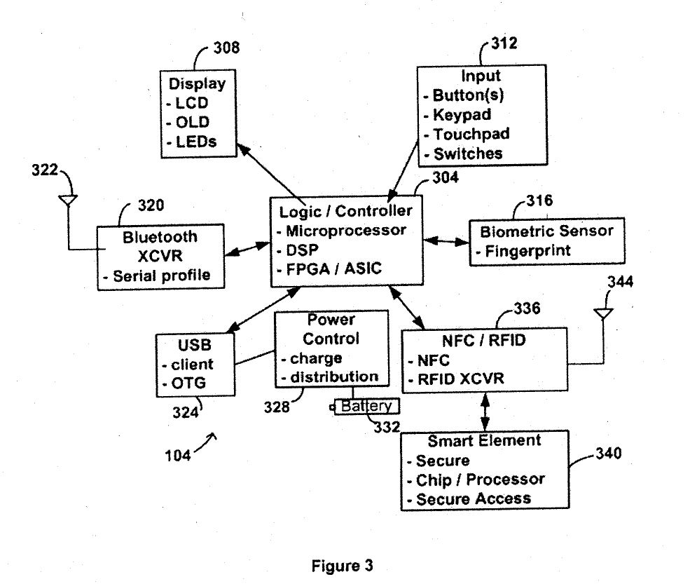

FIG. 3 illustrates a more detailed block diagram of the wireless smart card 104, as seen at 300. It will be appreciated that the wireless smart card 104 may include additional or fewer components than those shown in FIG. 3, and that the arrangement of the components may also differ from that shown in FIG. 3. The illustrated wireless smart card 300 includes a logic/controller 304, a display 308, a manually operable input device 312, a biometric sensor 316, a Bluetooth transceiver 320, a Universal Serial Bus (USB) connection 324, a power control 328, a battery 332, a NFC/RFID transceiver 336 and a secure element 340.

The logic/controller 304 is configured to control operation of the wireless smart card 300. In particular, the logic/controller 304 performs logic operations including, for example, user authentication, Bluetooth pairing, applet selection and power management. The logic/controller 304 may also be configured to control communications with other external devices in the transaction processing center 120. Firmware may be embedded in a flash memory of the controller to provide the intelligence, secure protocol and operation for the controller. In one particular embodiment, the controller and memory of the logic/controller 304 comprises a digital signal processor (DSP).

The wireless smart card 104 may optionally include a user interface. The user interface includes one or more of the display 308, manually operable input device 312 and biometric sensor 316. The display 308 may include status LEDs and/or a full liquid crystal display (LCD) to provide user feedback of the current operation of the wireless smart card 300. In one embodiment, the display 308 can be used to display one time password (OTP) information, as will be described in further detail below. The OTP can also be provided through the use of a mobile phone or PC through the USB port 127. The manually operable input device 312 can comprise one or more simple buttons and/or a full keypad. For example, the input device 312 may be an activation pushbutton connected to the logic/controller 304 that is configured to power on and/or activate the wireless smart card 104. The input device 312 can be used to wake up the device and/or for navigating and selecting operations. Also, the input device 312 can be used to manually select various modes of operations of the wireless smart card 300, as will be described in further detail below. It will be appreciated that the display 308 can also be used for user input (i.e., touch screen). In one embodiment, the biometric sensor 316 is a fingerprint sensor that is used for inputting security credentials. Biometric sensor 316 can also be used to select or control operations. For example, the direction of swipe or which finger is used can be detected to enable predetermined operations to be selected by a user. At initial set up, the user's biometric information may be entered and stored in the flash memory of the secure element 340. Once the wireless smart card 300 is configured, the biometric information from the sensor 316 can be used to compare and match a fingerprint at a later time to authenticate the user. The biometric information can also be used to authenticate secure communication lines.

Although the transceiver 320 is described as a Bluetooth transceiver, it will be appreciated that the transceiver 320 may operate under other communication protocols. The wireless transceiver 320 is configured to communicate with a mobile communication device, such as a cellular phone, via the antenna 322. The transceiver 320 can be a Bluetooth, WiFi, Ultra Wide Band, Infrared, or other wireless communication transceivers. Data communication via the transceiver 320 can be encrypted to augment security between a mobile communication device and the wireless smart card 300.

The Universal Serial Bus (USB) connection 324 is also an optional feature of the wireless smart card 300. The USB connection 324 can be used to connect the wireless smart card 300 with the mobile communication device (e.g., cellular phone) and/or a PC through a wired connection. The USB connection 324 can also be used to charge the battery 332 or provide power to the smart card 300 through a PC, some other external computing device, or a wall adaptor.

The power control 328 is configured to distribute power from the battery 332 or USB connection 324 to the components of the wireless smart card 300. The power control 328 also manages the charging of the battery 332 when the USB connection 324 is used to recharge the battery 332 or power the other components of the wireless smart card 300. It will be appreciated that if power is through the USB connection 324, the power will be a DC charge. Induction coupling or radio coupling can also be used to charge the battery 332 without a direct wire connection to the wireless smart card 300. The power control 328 is also configured to control power saving functions that shut down unnecessary circuitry of the wireless smart card 300 to save power and thus prolong the need for charging. The power saving operation can be enhanced by an event trigger design, as known in the art. In one embodiment, a near field signal from an external NFC device can be coupled to the power control 328 via the NFC antenna to energize the transponder circuit of the wireless smart card and trigger the power management to wake up the required circuitry.

The NFC and RFID transceiver 336 provides NFC and RFID communications. An NFC Antenna 344 is connected to the transceiver to transmit or receive the NFC or RFID signal. When connected to the secure element 340, the NFC/RFID transceiver 336 can be operated as the transponder to interact with external NFC/RFID devices. Also, standard RFID functions can be performed, enabling the device to be an RFID reader to scan and interact with other compatible tags.

The secure element 340 preferably includes a processor with access to various types of hardware encryption algorithms and secure flash memory. The secure element 340 allows the NFC transceiver 336 to operate like a transponder (tags) for contactless payment or other transactions. The secure element 340 stores applets, user credentials, transaction content or other secure information. The applets stored in the secure element 340 can preferably be configured to enable the wireless smart card 300 to perform various functions including coupon, rebate, loyalty programs, transit payment tokens, credit and debit card transactions, eTicketing, access control, etc. The applets are small application programs that enable the payment function and communications with the transaction device 112.

The wireless smart card can be used to generate a One-Time-Password (OTP). The OTP parameter and counter elements can be stored in the secure element 340 and displayed by the wireless smart card 300 or the mobile communication device 108. In certain secure transactions, an OTP is required by the transaction processing system for authentication of the transaction.

With reference to FIGS. 1-3, the wireless smart card 104 and the transaction processing system 100 can be used to perform transactions relating to Smart Posters, eTicketing, contactless payment, loyalty, etc. For example, in contactless payment transactions, customer credentials (e.g., credit card number, etc.) are passed from the wireless smart card 104 to the payment terminal 112a through the secure, wireless communication channel, by presenting the wireless smart card at the payment terminal 112a in a tap or wave fashion. The payment terminal 112a communicates the information to the transaction processing center 120 which processes the transaction using applicable standards. The details of the transaction can be communicated back to the wireless smart card 104 for review or verification by the consumer.

In another example, customers can use the wireless smart card 104 for network payments. The mobile communication device 108 can communicate with the wireless smart card 104 to make online purchases at the mobile communication device 108. The wireless smart card 104 transmits the transaction credentials stored at the wireless smart card 104 through the Bluetooth (or other personal area network) between the mobile communication device 108 and the wireless smart card 104). The transaction is processed by the transaction processing center 120 as known in the art.

In a further example, customers can use the wireless smart card 104 for loyalty or preferred customer programs. The consumer's loyalty programs or preferred customer details can be stored at the wireless smart card 104. A transaction device 112 can query the wireless smart card 104 for the loyalty program information to provide loyalty points, discounts or access. In addition, the consumer may use the points to purchase products or services that support the loyalty point program using the wireless smart card 104. The consumer can also review their loyalty points balance or offering at the wireless smart card 104 or through the wireless smart card 104 at the mobile communication device 108.

In yet another example, the wireless smart card 104 can be used for e-ticketing. The consumer can store purchased eTickets on their wireless smart card 104. When the user arrives at the event, the user can request the wireless smart card 104 display the eTicket at the mobile communication device 108 (or at the wireless smart card 104) to enter. The consumer can also exchange eTickets with other wireless smart cards 104 or other transaction devices that have NFC (e.g., transaction device 112c). Similarly, consumers can use the wireless smart card to store E-Coupons, which can be extracted at the appropriate time by the coupon offering company through their transaction device 112

The wireless smart card 104 can also be used to interact with smart posters. Smart posters are typically used to advertise an event, offering or product. The consumer can present the wireless smart card 104 to the tag location of the smart poster. Additional details can then be provided to the consumer or an offer to purchase may be provided to the user at the mobile communication device 108 through the wireless smart card 104 or by a link to more information from the net. For example, if a smart poster is advertising a new movie or show and the consumer presents the wireless smart card at the tag of the smart poster, a synopsis of the movie and local showings may be presented to the consumer at the mobile communication device 108. The user can also use the wireless smart card 104 to purchase tickets for the event electronically and use the eTicket to enter the movie.

The wireless smart card 104 can also be used for network pairing. Devices connected through Bluetooth or other personal area networks typically need to be paired. The wireless smart card 104 can allow pairing of other devices with the mobile communication device 108 through the Bluetooth or other personal area network by providing the key information in a secure manner.

The wireless smart card 104 can also be used to exchange business cards. The user can present their wireless smart card 104 to a NFC device (e.g., transaction device 112c) or another wireless smart card 104 to transmit the business card. Each wireless smart card 104 can then store the contact information in the contacts of the mobile communication device 108.

The wireless smart card 104 can also be used to securely store passwords. The passwords can then be accessed through the mobile communication device 108.

The wireless smart card 104 can be used for server authentication. A secure user access key can be associated with and stored on a wireless smart card 104 for secure access to online services, such as online banking, credit and financial information. When the user accesses the secure service, the wireless smart card 104 can be queried in a secure manner for dynamic authentication of the user.

The wireless smart card 104 is configured to allow for manual and/or automatic mode-switching. Exemplary modes include a power-on mode, a pairing mode, a provisioning and activation mode, a transaction mode, a contactless reader and writer mode, a peer to peer communication mode and a local transaction mode. Each mode involves processes and data exchange between the wireless smart card 104 and the mobile communication device 108 and/or transaction device 112. The operations modes are controlled by the logic and communication processing controller 136. The controller 136 can determine the modes based on the interaction or information of the external devices 112 (e.g., payment terminal 112a, NFC/RFID tags 112b, NFC devices 112c, etc). Modes can be manually selected by the user through the input functions of the wireless smart card 104 or mobile communication device 108.

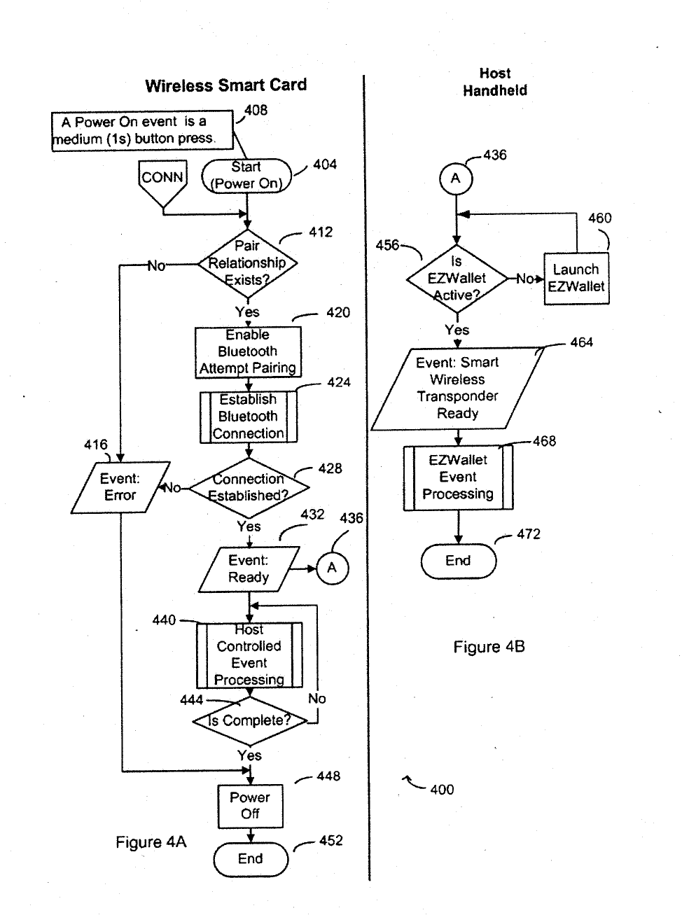

FIGS. 4A and 4B illustrate a preferred process 400 for powering on the wireless smart card (FIG. 4A) and mobile communication device (FIG. 4B). As shown in FIG. 4A, the process 400 begins at block 404. As shown in block 408, an exemplary power on event includes a button press for, in one example, 1 second. The process continues at block 412 by determining whether a pairing relationship exists. If a pair relationship does not exist, an event error occurs (block 416). If a pair relationship exists, the process 400 continues to enable the wireless smart card to attempt pairing using a Bluetooth protocol (block 420). The process 400 continues by establishing a Bluetooth connection (block 424). The process 400 then verifies whether a connection is established (block 428). If a connection is not established, the process 400 continues to block 416 (an event error). If a connection is verified, then the process 400 continues to Event: Ready (block 432). The process continues at block 436 at the handheld (see FIG. 4B). The process also continues at the wireless smart card, by the host controlled event processing (block 440). The process 400 then continues by determining whether the event process is complete (block 444). If no, the process 400 returns to block 440. If yes, the process 400 continues to power off (block 448). If an event error (block 416) occurred, the process 400 also continues to power off (block 448). The process 400 then ends (block 452) at the wireless smart card.

As described above, the process 400, at block 436, includes operations at the handheld wireless communication device, as shown in FIG. 4B. As shown in FIG. 4B, the process 400 continues by determining whether a handheld application residing on a service server, e.g., EZWallet, is active (block 456). If no, the EZWallet application is launched (block 460) and the process 400 continues back to block 456. If yes, the process continues to Event: Smart wireless transponder ready (block 464). The process 400 continues to the EZWallet Event processing (block 468). The process 400 then ends (block 472) at the host handheld.

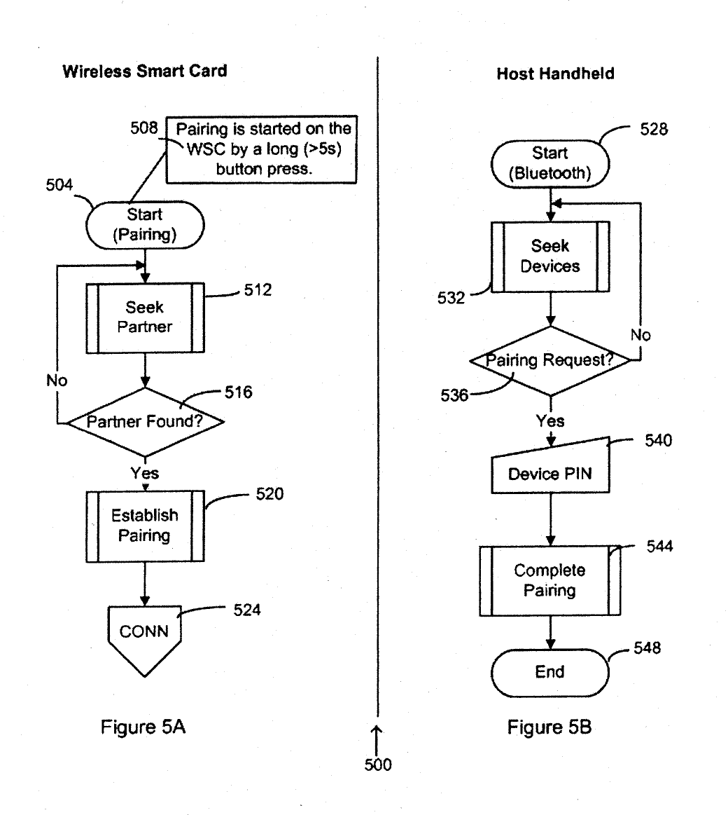

FIGS. 5A and 5B illustrate a preferred pairing process 500 at the wireless smart card (FIG. 5A) and the host handheld wireless communication device (FIG. 5B). The pairing process 500 preferably begins at block 504 by a long button press (e.g., five seconds or more) at the wireless smart card (block 508). The process 500 continues by seeking a partner (block 512). The process 500 then determines whether a partner is found (block 516). If no, the process 500 returns to block 512. If yes, the process continues by establishing pairing (block 520). The process 500 then continues to a connection state, CONN (block 524), which occurs after the wireless smart card is turned on (see FIG. 4A). As shown in FIG. 5B, the pairing process 500 includes starting a Bluetooth wireless protocol communication at the host handheld device (block 528). The process 500 continues by seeking devices (block 532). The process 500 then determines whether there is a pairing request from a wireless smart card (block 536). If no, the process returns back to block 532. If yes, the process continues by requesting/receiving a device PIN from the wireless smart card (block 540). The process 500 then continues by completing the pairing of the host handheld with the wireless smart card (block 544). The pairings process then ends (block 548).

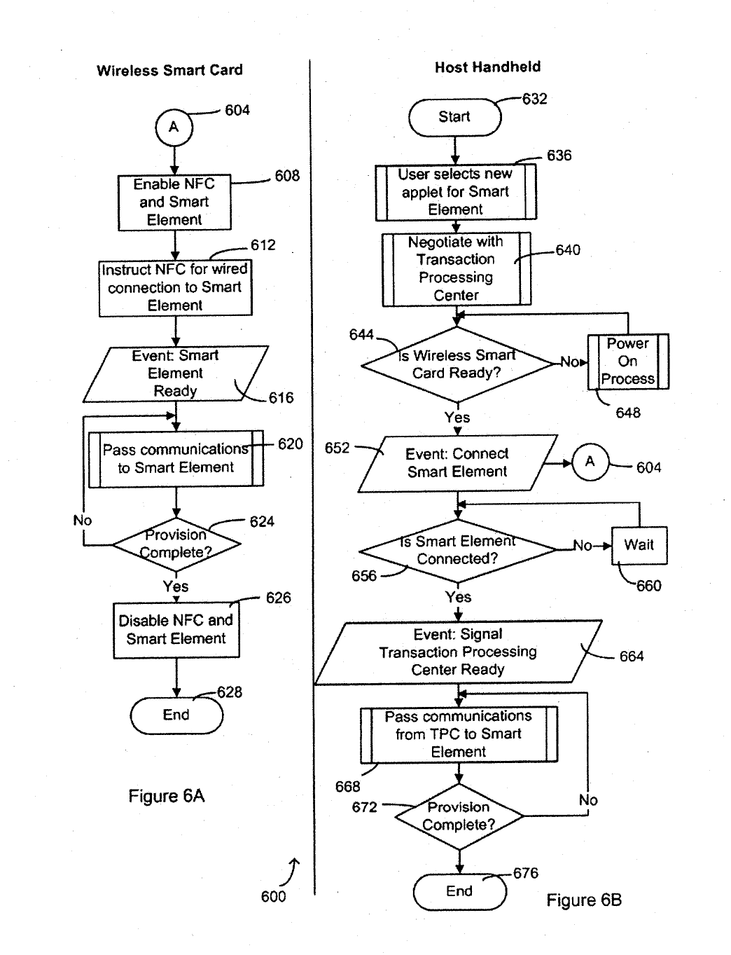

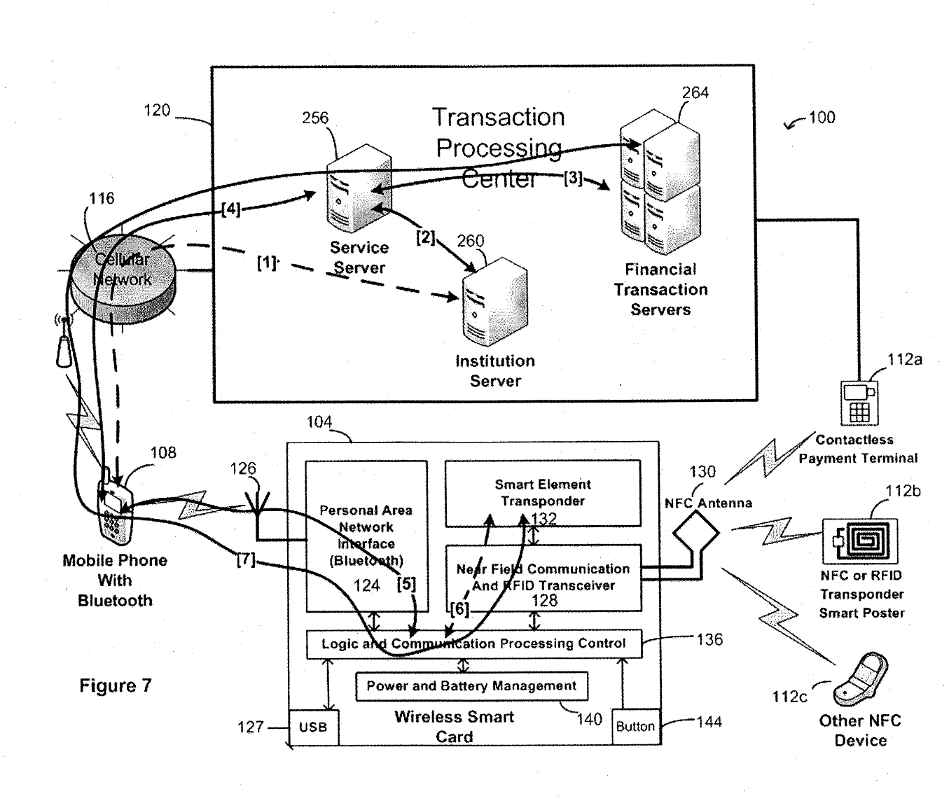

FIGS. 6A and 6B illustrate a provisioning and activation process 600 for the wireless smart card and host handheld mobile communication device. FIG. 7 illustrates the communication flow of the provisioning and activation process 600 with reference to FIG. 2. The provisioning and activation mode allows the transaction processing center (e.g., Banks, Credit Card Issuers, Cellular Operators or Payment Service Providers), to activate, store or modify the applets stored in the secure element 340.

FIG. 6A illustrates one embodiment of provisioning and activation at the wireless smart card 104 and FIG. 6B illustrates one embodiment of provisioning and activation at the host handheld (i.e., mobile communication device 108). As shown in FIG. 6A, the process 600 begins at the wireless smart card device at block 604. The process 600 continues by enabling the NFC and secure element (block 608). The process 600 continues by instructing the NFC for wired connection to the secure element (block 612). The process 600 continues with the Event: Secure element Ready (block 616). The process 600 continues by passing communications to the secure element (block 620). The process 600 then determines whether provisioning is complete (block 624). If no, the process 600 returns to block 620. If yes, the process 600 continues by disabling the NFC and secure element (block 626) and ends (block 628). As shown in FIG. 6B, the provisioning process 600 for the handheld mobile communication device begins at block 632. The process 600 continues by the user selecting a new applet for the secure element (block 636). The process 600 continues by negotiating with the transaction processing center (block 640). The process 600 continues by determining whether the wireless smart card is ready (block 644). If no, the process 600 continues with the power on process (block 648) and then returns to block 644. It will be appreciated that the power on process at block 648 is the power on process described above with reference to FIGS. 4A and 4B. If the wireless smart card is ready, the process 600 continues to Event: Connect Secure element (block 652), which causes the process at the wireless smart card to begin at block 604 as described with reference to FIG. 6A. The process 600 also continues by determining whether the secure element is connected (block 656). If no, the process 600 waits (block 660) and returns to block 656. If yes, the process 600 continues to Event: Signal transaction processing center ready (block 664). The process 600 then continues to pass communications from the transaction processing center to the secure element (block 668). The process 600 then determines whether provisioning is complete (block 672). If no, the process 600 returns to block 668. If yes, the provisioning and activating process ends at block 676.

With reference to FIG. 7, a mobile communication device user uses the mobile communication device 108 to surf to a desired activation site of an institution, such as a bank, department store, loyalty program, eTicket provider or other contactless enabled institution, at the institution server 260. The user provides or has pre-arranged criteria for allocation of contactless cards, such as a credit card or other payment card. The institution server 260 submits the request to the service server 256 (e.g., EZWallet service server). The service server 256 establishes a relationship with the appropriate financial transaction server(s) 264 with tokens provided by the institution server 260. The financial transaction server(s) 264 approve the transaction to load, provision and activate the service, which is communicated back to the service server 256. The service server 256 then establishes a secure link to the mobile communication device 108. On request of the service server 256, the interface of the mobile communication device 108 prompts the user to activate the wireless smart card 104 (e.g., by pushing an activation button of the smart wireless transponder). Upon user activation, the smart wireless transponder establishes a secure link to the mobile communication device 108 through the PAN (Bluetooth) wireless connection via the PAN transceiver 124. The control interface of the mobile communication device 108 then requests to establish a communication link with the secure element 132. Once all links are established, the mobile communication device 108 indicates to the financial transaction server(s) 264 through the service server 256 that communication to the secure element 132 is ready. The financial transaction server(s) 264 interacts directly with the secure element 132 through the secure communications established through the mobile communication device 108, and loads the appropriate applet to the secure element 132, provisions the applet with the user credentials and activates them for future use.

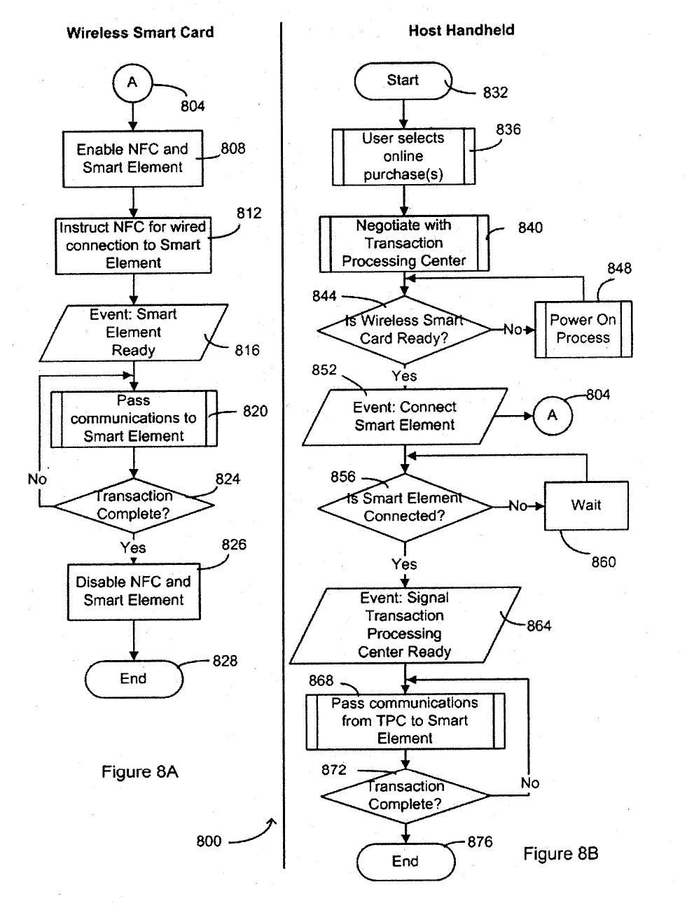

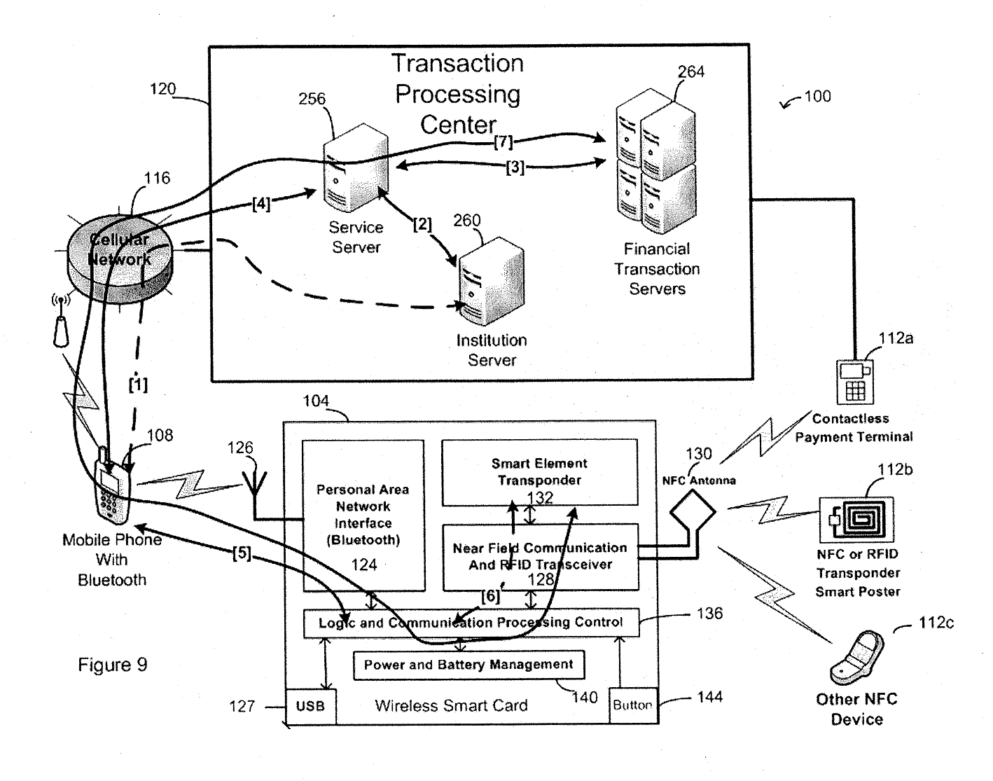

FIGS. 8A and 8B illustrate a network transaction process 800. FIG. 9 illustrates the communication flow of the network transaction process 800 with reference to FIG. 2. An exemplary network transaction is the exchange of secure information with web services or online transactions through the mobile communication device 108.

FIG. 8A illustrates a preferred network transaction process at the wireless smart card 104 and FIG. 8B illustrates a preferred network transaction process at the host handheld (e.g., mobile communication device 108). The process 800 begins at the wireless smart card 104 at block 804. The process 800 continues by enabling the NFC and secure element (block 808). The process 800 continues by instructing the NFC for wired connection to the secure element (block 812). The process 800 continues with the Event: Secure element Ready (block 816). The process 800 continues by passing communications to the secure element (block 820). The process 800 then determines whether the transaction is complete (block 824). If no, the process 800 returns to block 820. If yes, the process 800 continues by disabling the NFC and secure element (block 826) and ends (block 828). As shown in FIG. 8B, the network transaction process 800 begins at block 832. The process 800 continues with the user selecting an online purchase (block 836). The process 800 continues by negotiating with the transaction processing center (block 840). The process 800 then determines whether the wireless smart card is ready (block 844). If no, the process 800 continues with the power on process (block 848) and then returns to block 844. It will be appreciated that the power on process at block 848 is the power on process described above with reference to FIGS. 4A and 4B. If yes, the process 800 continues to Event: Connect Secure element (block 852), which causes the process at the wireless smart card to begin at block 804 as described with reference to FIG. 8A. The process 800 also continues by determining whether the secure element is connected (block 856). If no, the process 800 waits (block 860) and returns to block 856. If yes, the process 800 continues to Event: Signal transaction processing center ready (block 864). The process 800 then continues to pass communications from the transaction processing center to the secure element (block 868). The process 800 then determines whether the transaction is complete (block 872). If no, the process 800 returns to block 868. If yes, the process ends at block 876.

With reference to FIG. 9, the user preferably establishes an online session at the mobile communication device 108 as shown to, for example, make a purchase or transfer funds with an institution at the institution server 260. The institution server 260 requests to clear the transaction at the service server 256. The service server 256, using tokens from the institution server 260, requests for processing of the transaction at the financial transaction server(s) 264. On approval to proceed with the transaction from the institution 260, the service server 256 requests the mobile communication device 108 establish connection with the secure element 132 of the wireless smart card 104. The mobile communication device 108 may prompt the user to activate secure element 132 by, for example, pressing a button. When the secure element 132 is activated, the secure element 132 establishes a secure connection through the PAN (Bluetooth) transceiver 124 to the mobile communication device 108. Upon connection, the service application of the mobile communication device 108 requests connection with the secure element 132. Through the established secure connection, the financial transaction server(s) 264 process the transaction with the users preloaded criteria stored at the secure element 132.

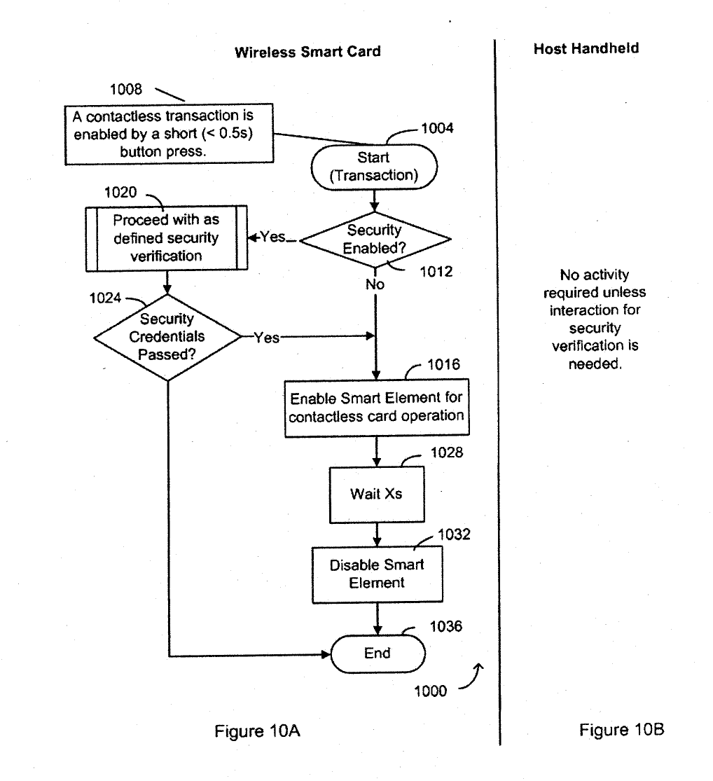

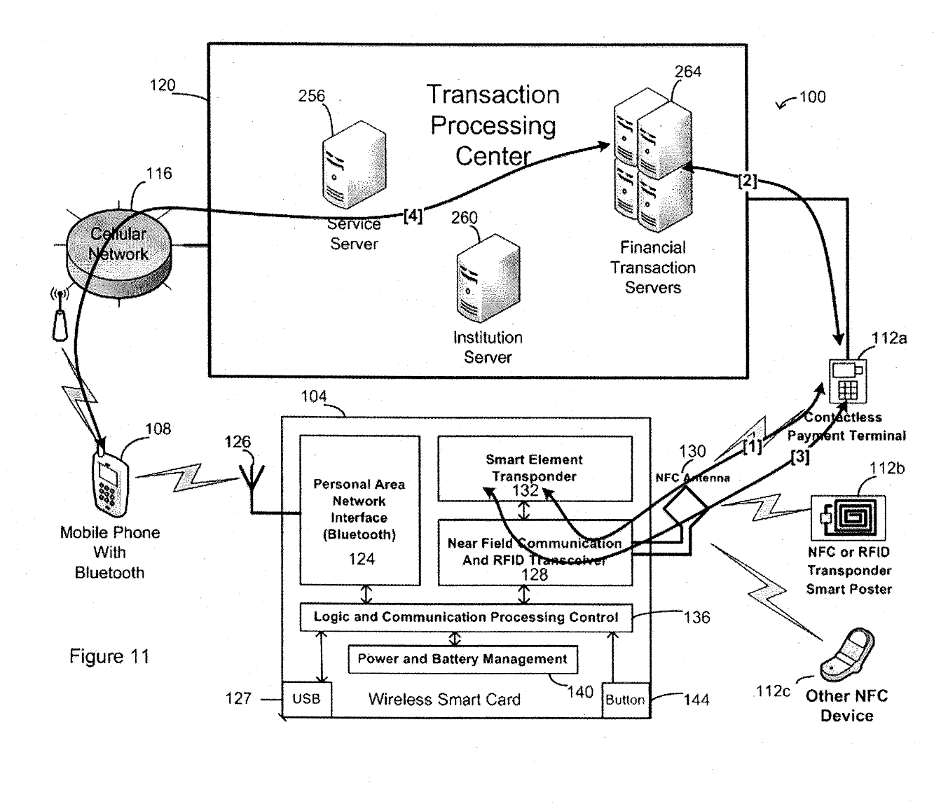

FIGS. 10A and 10B illustrate a preferred contactless transaction process 1000. FIG. 11 illustrates the communication flow of the contactless transaction process 1000 with reference to FIG. 2. FIG. 10A illustrates the process 1000 at the wireless smart card 104 and FIG. 10B illustrates the process 1000 at the host handheld (i.e., mobile communication device 108). As shown in FIG. 10B, no activity is required unless interaction for security verification is needed at the mobile communication device 108. Referring to FIG. 10A, the process 1000 begins at block 1004 by, for example, pressing a button for a shore time (e.g., less than 0.5 s) at block 1008. The process 1000 continues by determining whether security is enabled (block 1012). If no, the process 1000 continues to enable the secure element for contactless card operation (block 1016). If yes, the process 1000 continues to proceed with as defined security verification (block 1020). The process 1000 then determines whether security credentials passed (block 1024). If no, the process ends (block 1036). If yes, the process 1000 returns to block 1016. From block 1016, the process 1000 continues to wait Xs (block 1028). The process 1000 continues to disable the secure element (block 1032) and ends (block 1036).

FIG. 11 illustrates a preferred process for contactless transactions through a contactless payment terminal 112a. In response to an activation step initiated by a user of the wireless smart card 104, e.g., by pressing a button or entering a passcode on the smart card 104, information from the users account or other transaction details are provided to the host terminal 112a through a network communication packet (e.g., SMS). When the user is at the contactless payment terminal 112a at a kiosk or retailer and the retailer has entered the transaction amount at the payment terminal 112a, the user presents the wireless smart card 104 within the field of the contactless payment terminal 112a. The payment credentials are passed in a defined, secure way to the payment terminal 112a through the NFC and RFID interface 128 from the secure element 132. The payment terminal 112a authenticates transaction with the financial transaction server(s) 256. In one embodiment, the terminal 112a may pass the transaction details back to the secure element 132 for record keeping. In another embodiment, the financial transaction server(s) 256 may pass the transaction details to mobile communication device 108 over the cellular network 116 through, for example, SMS.

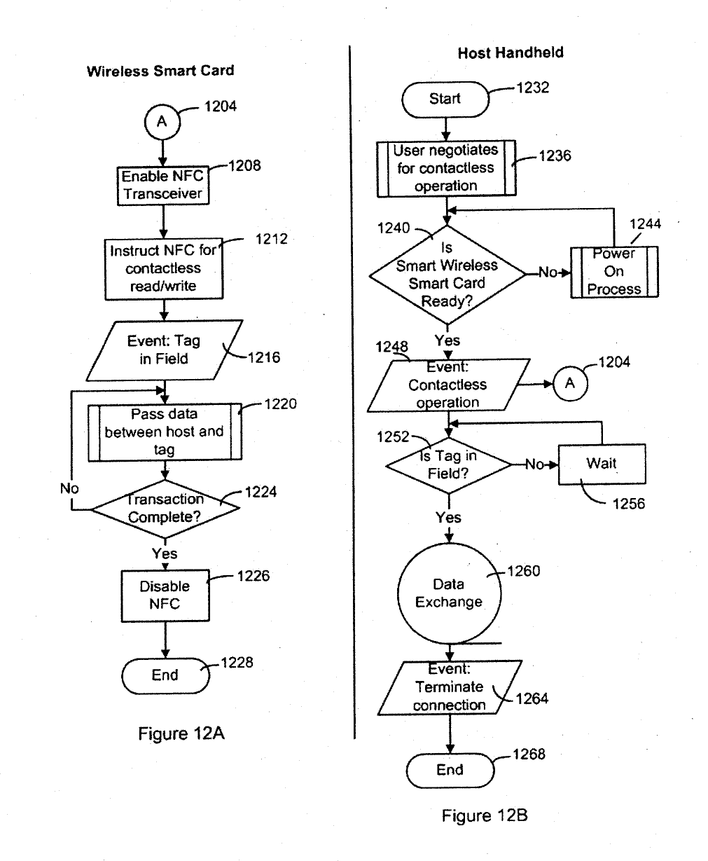

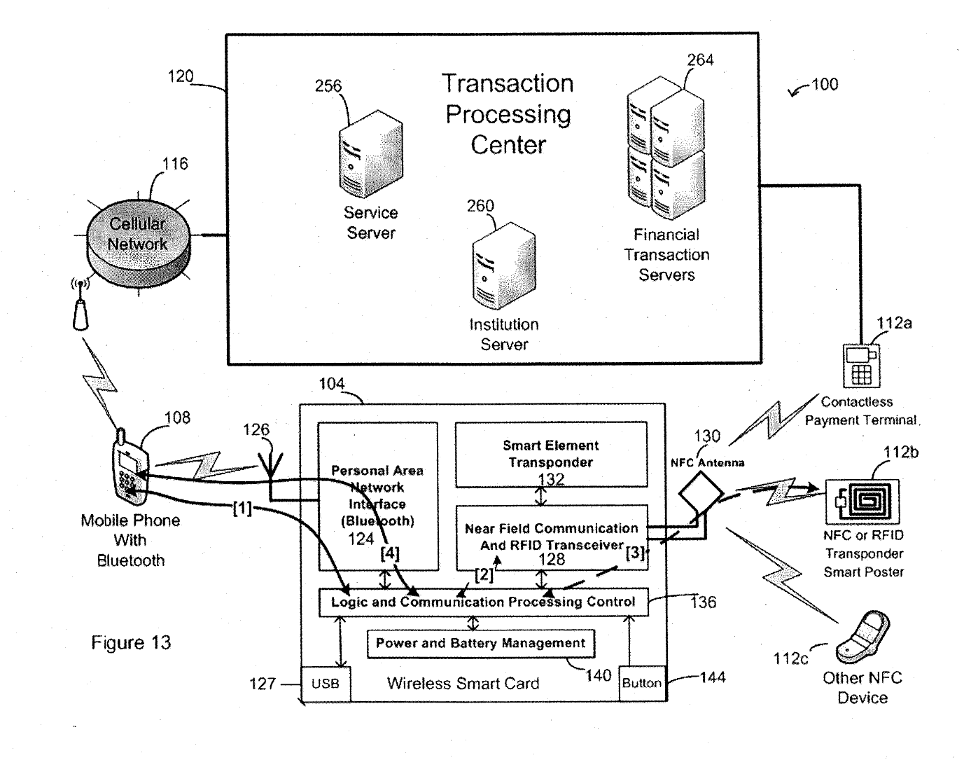

FIGS. 12A and 12B illustrate a preferred contactless reader and writer mode process 1200. FIG. 13 illustrates the communication flow of the contactless reader and writer mode process 1200 with reference to FIG. 2.

FIG. 12A illustrates the contactless reader and writer process at the wireless smart card 104 and FIG. 12B illustrates the contactless reader and writer process at the host handheld (i.e., mobile communication device 108). The process 1200 begins at the wireless smart card 104 at block 1204. The process 1200 continues by enabling the NFC transceiver (block 1208). The process 1200 continues by instructing the NFC for contactless read/write (block 1212). The process 1200 continues by Event: Tag in Field (block 1216). The process 1200 continues by passing data between the host and tag (block 1220). The process 1200 continues by determining whether the transaction is complete at block 1224. If no, the process 1200 returns to block 1220. If yes, the process 1200 continues by disabling NFC (block 1226) and ends (block 1228). As shown in FIG. 12B, the network transaction process 1200 begins at block 1232. The process 1200 continues with the user negotiating for contactless operation (block 1236). The process 1200 then determines whether the wireless smart card is ready (block 1240). If no, the process 1200 continues with the power on process (block 1244) and then returns to block 1240. It will be appreciated that the power on process at block 1244 is the power on process described above with reference to FIGS. 4A and 4B. If yes, the process 1200 continues to Event: Contactless Operation (block 1248), which causes the process at the wireless smart card to begin at block 1204 as described with reference to FIG. 12A. The process 1200 also continues by determining whether the tag is in field (block 1252). If no, the process 1200 waits (block 1256) and returns to block 1252. If yes, the process 1200 continues to Data Exchange (block 1260). The process 1200 then continues to Event: Terminate Connection (block 1264) and ends (block 1268).

With reference to FIG. 13, when the contactless (NFC or RFID) reader and writer mode of the wireless smart card 104 is activated, the NFC and RFID interface 128 generates a radio signal that energizes the NFC or RFID tag 112b (transponder, e.g., e-Poster, RFID product label, etc.). When the tag 112b is energized, the wireless smart card 104 can read or write data from/to the tag 112b. The wireless smart card 104 can then also communicate with the mobile communication device 108 via Bluetooth through the PAN transceiver 124 to open the corresponding application of the mobile communication device 108 according to the tag information being processed by the wireless smart card 104. The user can view, store, or use the tag information (e.g., eTicket, product price, URL, etc.) to enter a transaction (e.g purchase the ticket or product, or access the web for more information based on the URL).

For example, when the user wants to read a smart poster or other RFID tagged device 112b, the user utilizes the contactless read/write operation of the wireless smart card 104. The user activates the secure element 132 by, for example, pushing a button on the wireless smart card 104 to activate the eZWallet system by establishing a connection to the mobile communication device 108 through the PAN transceiver 124. The mobile communication device 108 automatically launches the eZWallet application. The wireless smart card 104 also activates the NFC or RFID interaction mode, enabling the NFC/RFID interface 128. When the NFC or RFID transponder tag 112b is presented in the field of the secure element 132, the NFC or RFID tag information is read or data is exchanged based on the policies of the information stored in tag. The tag information is exchanged with the application running on the mobile communication device 108. The mobile communication device 108 can then, for example, establish exchange of information with a Web or SMS service (e.g., FIGS. 8A-9), list information in the mobile communication device application for later processing, create a transaction process with a web service or with the wireless smart card 104 for interaction with a contactless payment terminal 112a (e.g., FIGS. 10A-11), or the like.

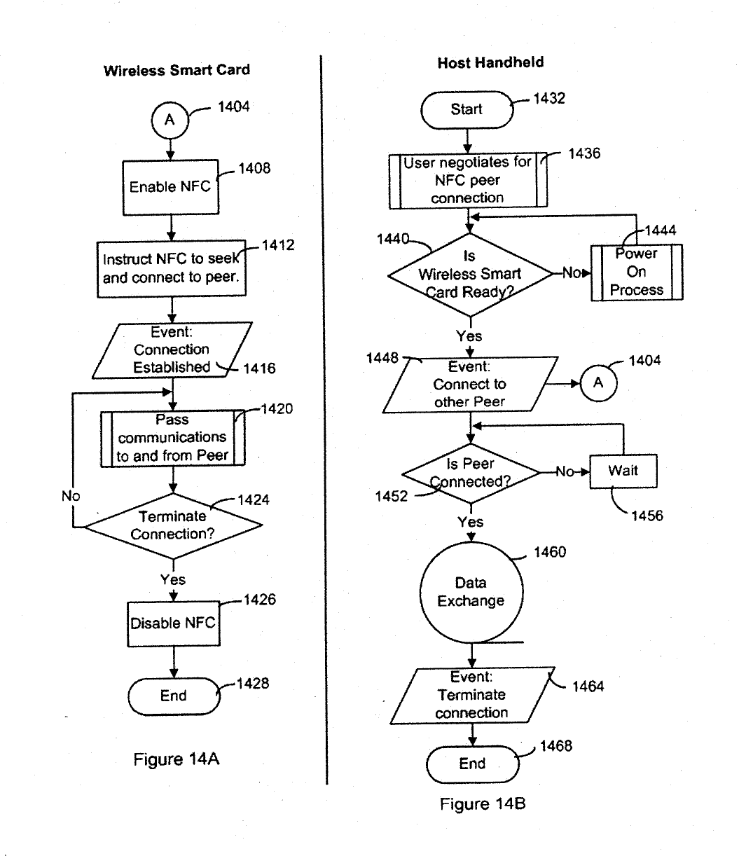

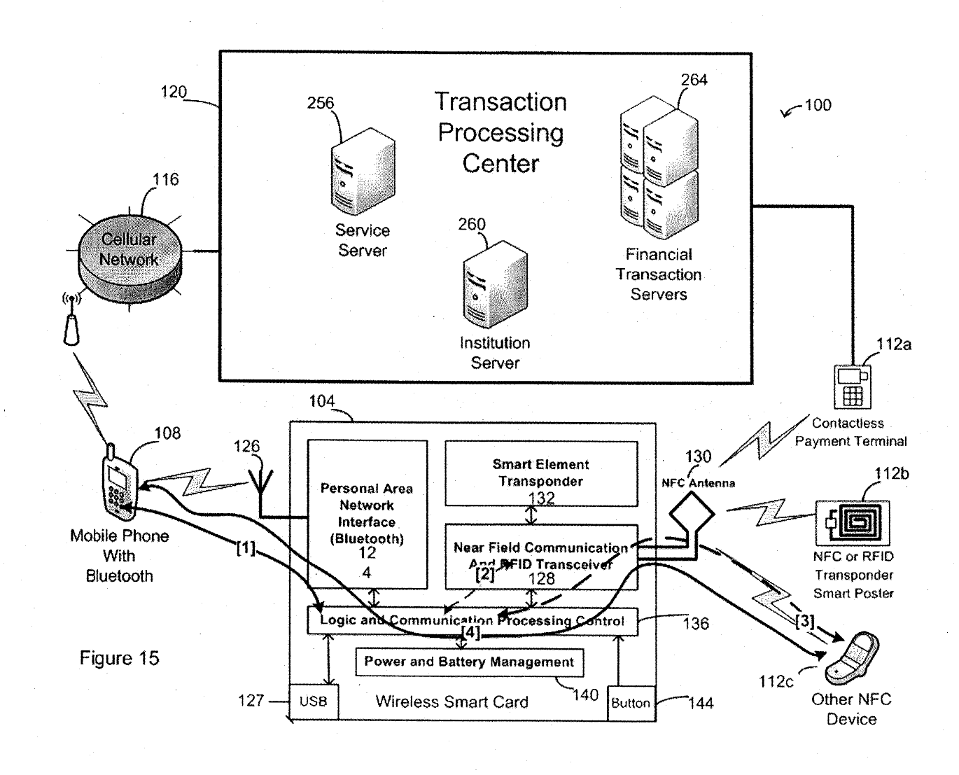

FIGS. 14A and 14B illustrate a preferred peer to peer communication process 1200. FIG. 15 illustrates the data flow of the peer to peer communication process 1400 with reference to FIG. 2. The peer to peer communication mode is used when the wireless smart card 104 is establishing two-way communication with another NFC enabled device.

FIG. 14A illustrates peer to peer communication at the wireless smart card 104 and FIG. 14B illustrates peer to peer communication at the host handheld (i.e., mobile communication device 108). As shown in FIG. 14A, the process 1400 begins at the wireless device at block 1404. The process 1400 continues by enabling the NFC and secure element (block 1408). The process 1400 continues by instructing the NFC to seek and connect to a peer (block 1412). The process 1400 continues with the Event: Connection established (block 1416). The process 1400 continues by passing communications to and from the peer (block 1420). The process 1400 then determines whether connection is terminated (block 1424). If no, the process 1400 returns to block 1420. If yes, the process 1400 continues by disabling the NFC and secure element (block 1426) and ends (block 1428). As shown in FIG. 14B, the peer to peer communication process 1400 begins at block 1432. The process 1400 continues by the user negotiating for NFC peer connection (block 1436). The process 1400 continues by determining whether the wireless smart card is ready (block 1440). If no, the process 1400 continues with the power on process (block 1444) and then returns to block 1440. It will be appreciated that the power on process at block 1444 is the power on process described above with reference to FIGS. 4A and 4B. If yes, the process 1400 continues to Event: Connect to Other Peer (block 1448), which causes the process at the wireless smart card to begin at block 1404 as described with reference to FIG. 14A. The process 1400 also continues by determining whether the peer is connected (block 1452). If no, the process 1400 waits (block 1456) and returns to block 1452. If yes, the process 1400 continues to Data Exchange (block 1460). The process 1400 then continues to Event: Terminate connection (block 1464) and ends at block 1468.

Referring to FIG. 15, the wireless smart card 104 through the NFC and Bluetooth communication links through the NFC and RFID interface 128 and the PAN transceiver 124, respectively, acts as a communication agent to relay, process, interpret or exchange information from the other NFC device(s) 112c to the mobile communication device 108. The user may activate the secure element 132 by, for example, pressing a button on the wireless smart card 104. Connection is established between the wireless smart card 104 and the mobile communication device 108 through the PAN (Bluetooth) transceiver 124. The mobile communication device 108 launches an application, e.g., the eZWallet application. The wireless smart card 104 also activates the NFC or RFID interaction mode, enabling the NFC/RFID interface 128. Another NFC device 112c is presented to field of the wireless smart card 104 and a peer to peer connection link is established between the other NFC device 112c and mobile communication device 108 for peer to peer exchange of information. The eZWallet application can then utilize local information for data exchange or communicate through the network 116 to other services (e.g., service server 256, institution server 256 and/or financial transaction servers 264).

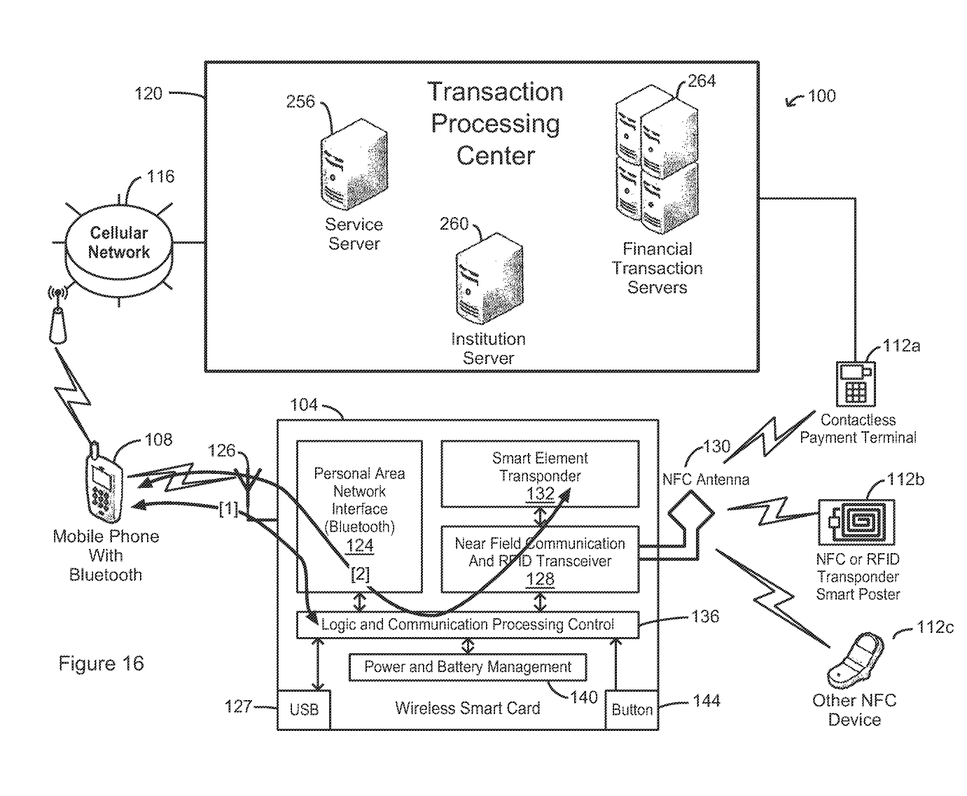

FIG. 16 illustrates the data flow for a preferred embodiment of a local transaction mode 1600. The wireless smart card 104 can also be utilized for local transactions (i.e., transactions between the mobile communication device 108 or other user host device, handheld or PC that utilize the secure element 132 to access specialized or personal applets). Examples of localized transactions include a password container, a one-time password and preference settings. The password container allows users to enter a single password to access an applet that is a container of all passwords for that user. The user can access and remind themselves about their passwords when needed. The wireless smart card 104 can be used to generate the One-Time-Password (OTP). OTP is an established means of creating dynamic credentials for authentication, which is used by many financial institutions have the OTP option for added security of online transactions. The OTP parameter and counter elements can be stored in the secure element 132 of the wireless smart card 104 and displayed by the wireless smart card 104 or by the mobile communication device 108 (OTP information is communicated to the mobile communication device via Bluetooth and PAN transceiver 124). The preference settings of the secure element 132 may involve interaction with a local applet. Examples of preference settings include setting a default credit card to MasterCard first, Amex second or a personal credit card first, business credit card second. Other exemplary local transactions include picture storage/transfer, application storage/transfer (e.g., patient logs, insurance information, timecards, inventory systems, asset tracking, etc.), note pad data, reminder (tasks), scheduling, and the like.

In FIG. 16, the user first activates the wireless smart card 104 by, for example, pressing a button. The user selects operation for a local transaction mode on the mobile communication device 108. The mobile communication device 108 instructs the wireless smart card 104 to connect the secure element 132. The mobile communication device 108 then communicates directly with the secure element 132 through Bluetooth using the PAN transceiver 124 or through a USB connection to exchange data between the wireless smart card 104 and the mobile communication device 108.

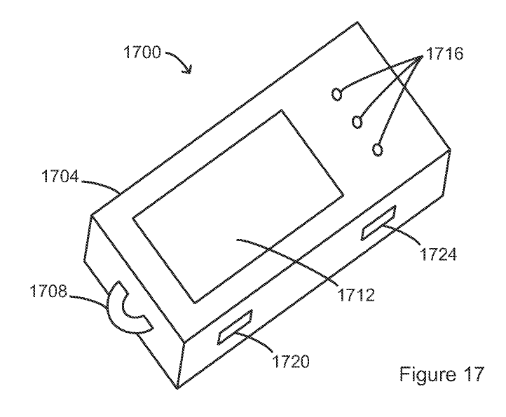

FIG. 17 illustrates an exemplary configuration of a key fob wireless smart card 1700. The illustrated wireless smart card 1700 includes a housing 1704 that includes a key chain feature 1708, a fingerprint sensor 1712, status LEDs 1716, an activation pushbutton 1720, and a USB port 1724. It will be appreciated that the wireless smart card, however, may have a number of different configurations and the one shown in FIG. 17 is merely exemplary.

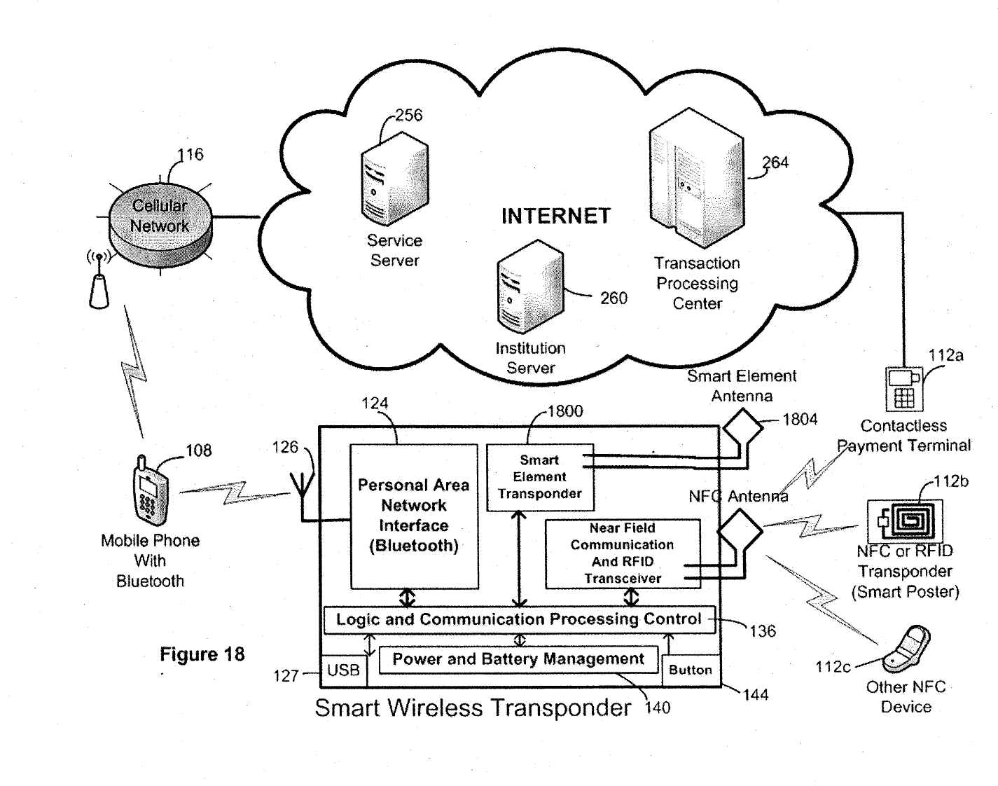

FIG. 18 illustrates another embodiment of the wireless smart card system 100 in which the wireless smart card 104 has a different arrangement from that shown in FIGS. 1 and 2. As shown in FIG. 18, the secure element transponder 1800 of the wireless smart card 104 may be independent of the NFC and RFID transceiver 128. In FIG. 18, the secure element transponder 1800 includes a secure element antenna 1804.

The secure element transponder 1800 is a dual interface integrated circuit (IC) that supports both direct and contactless communications. In this embodiment, the logic controller 136 controls the secure element transponder 1800 and NFC and RFID transceiver 128 to isolate operation such that one or the other (i.e., secure element transponder 1800 or NFC and RFID transceiver 128) is operating at a given time. This allows the coexistence of antennas (e.g., wireless smart card 104 includes both secure element antenna 1804 and NFC antenna 130) or sharing of antenna (e.g., wireless smart card 104 includes NFC antenna 130 or secure element antenna 1804). In the embodiment illustrated in FIG. 18, the secure element transponder 1800 can be also be used in contactless transactions with limited or no power requirements as described above with respect to the NFC and RFID transceiver 128.

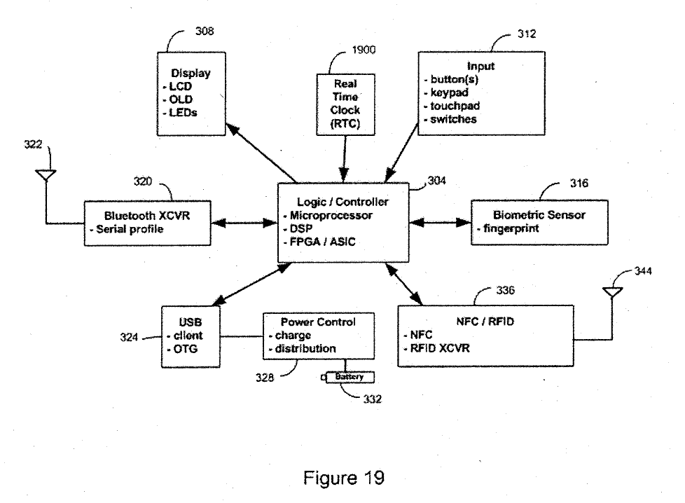

FIG. 19 illustrates another embodiment of the wireless smart card 104 in which the wireless smart card 104 includes a real time clock (RTC) 1900 coupled to the logic/controller 304. It will be appreciated that the RTC 1900 may be needed when a one-time password (OTP) is being used at the wireless smart card 104.

An advantage of the wireless smart card and wireless transaction systems and methods described herein includes the early adoption or realization in the contactless/NFC/contactless payment industry. Users are able to utilize NFC and contactless payment processes through their mobile communication device or other handheld device without getting a new phone, by using technology already existing in the user's phone (e.g., Bluetooth).

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A wireless smart card comprising:
a personal area network (PAN) interface;
a near field communication (NFC) and radio frequency identification (RFID) transceiver;
a secure element coupled to the NFC and RFID transceiver;
a processor coupled to the PAN interface, the NFC and RFID transceiver and the secure element; and
a memory coupled to the processor.

2. The wireless smart card of claim 1, wherein the secure element is coupled to the NFC and RFID transceiver through the processor.

3. The wireless smart card of claim 1, further comprising a real-time clock coupled to the processor.

4. The wireless smart card of claim 1, wherein the PAN interface is for enabling the wireless smart card to communicate with a wireless mobile communication device.

5. The wireless smart card of claim 1, wherein the PAN interface comprises a PAN transceiver.

6. The wireless smart card of claim 1, wherein the PAN interface comprises a USB connector.

7. The wireless smart card of claim 1, further comprising a display coupled to the processor.

8. The wireless smart card of claim 1, further comprising a rechargeable battery and charger circuit coupled to the processor.

9. The wireless smart card of claim 1, further comprising a biometric fingerprint reader coupled to the processor.

10. The wireless smart card of claim 1, further comprising a manually operable input device coupled to the processor.

11. The wireless smart card of claim 10, wherein the manually operable input device comprises an activation button.

12. The wireless smart card of claim 1, wherein the PAN interface is a Bluetooth transceiver.

13. The wireless smart card of claim 1, wherein the NFC and RFID transceiver comprises a NFC transceiver or an RFID transceiver.

14. The wireless smart card of claim 1, wherein the NFC and RFID transceiver is configured to be wirelessly connected to a contactless transaction terminal.

15. The wireless smart card of claim 1, wherein the secure element is configured to be wirelessly connected to a transaction server through the NFC and RFID transceiver.

16. The wireless smart card of claim 1, wherein the secure element is configured to be wirelessly connected to a service server through the PAN interface.

17. The wireless smart card of claim 1, wherein the secure element comprises applets configured to enable a payment function.

18. The wireless smart card of claim 1, wherein the secure element comprises applets configured to enable a communication function.

19. The wireless smart card of claim 1 wherein the wireless smart card is configured to selectively operate in one of a plurality of modes.

20. The wireless smart card of claim 19 wherein the wireless smart card is configured to automatically detect the one of the plurality of modes for a transaction.

21. The wireless smart card of claim 19 wherein the plurality of modes comprises a passivation and activation mode, a network transaction mode, a contactless payment mode, a read/write mode, and a peer-to-peer communication mode.
